(19) United States
(12) Patent Application Publication
(10) Pub. No.: US 2023/0176322 A1
(43) Pub. Date: Jun. 8, 2023

(54) ROTATIONAL POSITION SENSOR

(71) Applicant: BUSHNELL INC., Overland Park, KS (US)

(72) Inventor: Michael A. Sizemore, Overland Park, KS (US)

(21) Appl. No.: 18/076,035

(22) Filed: Dec. 6, 2022

Related U.S. Application Data
(63) Continuation-in-part of application No. 17/543,685, filed on Dec. 6, 2021.

(51) Int. Cl. G02B 7/10; G01B 7/00; G01B 7/24; G01B 7/30; F41G 1/38

(52) U.S. Cl. CPC G02B 7/102; G01B 7/003; G01B 7/24; G01B 7/30; F41G 1/38

(57) ABSTRACT

A rotational position sensor assembly for detecting the selected rotational position of a rotatable selector is provided including a reference member positioned about an axis; one or more proximity sensors disposed on the reference member; a rotatable selector defining an inner surface, the rotatable selector mounted about the reference member and rotatable about the axis, the inner surface and the proximity sensor defining a gap there between, wherein the gap varies with respect to the rotational position of the rotatable selector, the one or more proximity sensors generating signal(s) proportional to the size of the gap; and a processor and a non-transitory computer readable storage medium, the computer readable storage medium including instructions executable by the processor to receive signal(s) proportional to the size of the gap from the one or more proximity sensors; and correlate the signal(s) with a rotational position of the rotatable selector.

### CROSS REFERENCE TO RELATED APPLICATIONS

This application is a Continuation-in-part of U.S. patent application Ser. No. 17/543,685, filed Dec. 6, 2021, incorporated by reference in its entirety herein.

### FIELD

The field of the present disclosure relates to sensors for detecting the rotational position of a selector and providing an output signal relating to the detected position.

### DESCRIPTION OF RELATED ART

Many electro-mechanical devices include user-selected settings, such as magnification, focus, aperture opening, volume, power level, etc., which are provided by an input device, such as a rotatable selector, such as a knob or a ring. Such user-selected settings are often required for other purposes in operation of the device, such as the user interface or other user-assistance features. Typically, once the user selection is made, the user can view the selection made by the selector, and manually enter the selection into the user interface for further use. Optimally, the selection is automatically detected by the apparatus without further user input.

U.S. Pat. No. 6,253,630 describes a system for detecting the rotational position of a steering wheel. This system relies on a resistance sheet disposed on the steering column and wipers that are in contact with the steering shaft. Depending on the rotational position of the steering wheel, a level of voltage is defined, analogous to the operation of a standard commercially available potentiometer. The rotational position of the steering wheel can be determined on the basis of these voltages. This technique requires the moving and non-moving components to be in physical contact at all times.

U.S. Pat. No. 8,196,835 provides a method of determining the position of an object. Position markers, encoded with their identity, are viewed with a camera, images are captured and processed, and the position and rotational orientation of the object are calculated. This technique requires the use of a large number of position markers, each having their information pre-stored.

Accordingly, there is a need for a sensor to detect the position of a selector device that is accurate and that does not require extensive hardware or data for use.

### SUMMARY

In one aspect of the disclosed subject matter, provided is a rotational position sensor assembly for detecting the selected rotational position of a rotatable selector comprising: a reference member positioned about an axis; one or a plurality of proximity sensors disposed on the reference member; a rotatable selector defining an inner surface, the rotatable selector mounted about the fixed reference member and rotatable about the axis, the inner surface and the proximity sensor defining a gap there between, wherein the gap varies with respect to the rotational position of the rotatable selector, the proximity sensor generating a signal proportional to the size of the gap; and a processor and a non-transitory computer readable storage medium, the computer readable storage medium including instructions executable by the processor to: receive signals proportional to the size of the gap from the one or the plurality of proximity sensors; and correlate the signals with a rotational position of the rotatable selector.

Embodiments include the following alone or in any combination.

The rotational position sensor wherein the processor is further configured to correlate the rotational position of the rotatable selector with a user selected setting.

The rotational position sensor assembly wherein the processor is further configured to generate an output signal corresponding to the user selected setting.

The rotational position sensor assembly wherein the user selected setting is a magnification setting.

The rotational position sensor assembly wherein the reference member is a ring defining a central opening.

The rotational position sensor assembly one or the plurality of proximity sensors are optical proximity sensors.

The rotational position sensor wherein the gap includes a range of 1-5 mm.

The rotational position sensor assembly wherein the selector is a ring.

The rotational position sensor assembly wherein the one or the plurality of proximity sensors are operated at a plurality of power levels.

The rotational position sensor assembly comprising the plurality of proximity sensors.

Another aspect provides a rotational position sensor assembly for detecting the selected rotational position of a rotatable selector comprising: a fixed reference member positioned about an axis and defining a first surface; a rotatable selector mounted about the fixed reference member and rotatable about the axis, the rotatable selector defining a second surface opposing the first surface; one or a plurality of proximity sensors disposed on one of the fixed reference member and the rotatable selector, wherein the one or the plurality of proximity sensors and the second surface define a gap therebetween when one or the plurality of proximity sensors are disposed on the fixed reference member and the proximity sensor and the first surface define the gap therebetween when the one or the plurality of proximity sensors are disposed on the rotatable selector, wherein the gap varies with the rotational position about the axis of the rotatable selector with respect to the fixed reference member, the one or the plurality of proximity sensors generating signals proportional to the size of the gap; and a processor and a non-transitory computer readable storage medium, the computer readable storage medium including instructions executable by the processor to: receive signals proportional to the size of the gap from the one or the plurality of proximity sensors; and correlate the signals with a rotational position of the rotatable selector.

Embodiments include the following, alone or in any combination.

The rotational position sensor assembly wherein the processor is further configured to correlate the rotational position of the rotatable selector with a user selected setting.

The rotational position sensor assembly wherein the user selected setting is a magnification setting.

The rotational position sensor assembly wherein the fixed reference member is a ring defining a central opening.

The rotational position sensor assembly wherein the one or the plurality of proximity sensors are optical proximity sensors.

The rotational position sensor assembly wherein the gap includes a range of 1-5 mm.

The rotational position sensor assembly wherein the processor is further configured to generate an output signal corresponding to the user selected setting.

The rotational position sensor assembly wherein the selector is a ring.

The rotational position sensor assembly wherein the one or the plurality of proximity sensors are operated at a plurality of power levels.

The rotational position sensor assembly comprising the plurality of proximity sensors.

A rotational position sensor assembly for detecting the selected rotational position of a rotatable selector is provided including a fixed reference member positioned about an axis and defining a first surface; a rotatable selector mounted about the fixed reference member and rotatable about the axis, the rotatable selector defining a second surface opposing the first surface; a proximity sensor disposed on one of the fixed reference member and the rotatable selector, wherein the proximity sensor and the second surface define a gap therebetween when the proximity sensor is disposed on the fixed reference member and the proximity sensor and the first surface define the gap therebetween when the proximity sensor is disposed on the rotatable selector, wherein the gap varies with the rotational position about the axis of the rotatable selector with respect to the fixed reference member, the proximity sensor generating a signal proportional to the size of the gap; and a processor and a non-transitory computer readable storage medium, the computer readable storage medium including instructions executable by the processor to receive the signal proportional to the size of the gap from the proximity sensor; and correlate the signal with a rotational position of the rotatable selector.

In some embodiments, the processor is configured to correlate the rotational position of the rotatable selector with a user selected setting. In some embodiments, the processor is configured to generate an output signal corresponding to the user selected setting.

In some embodiments, the user selected setting is a magnification setting. In some embodiments, the fixed reference member is a ring defining a central opening. In some embodiments, the proximity sensor is an optical proximity sensor. In some embodiments, the gap includes a range of 1-5 mm. In some embodiments, the selector is a ring.

In some embodiments, the rotational position sensor assembly comprises a plurality of proximity sensors disposed on the fixed reference member or the rotatable selector, wherein each of the proximity sensors generates a signal proportional to the size of the gap between the fixed reference member and the rotatable selector and the processor receives the signals proportional to the size of the gap from each of the proximity sensors; and correlates the signals with the rotational position of the rotatable selector. In some embodiments, the plurality of sensors are disposed at different angular positions around the axis. In some embodiments, the plurality of sensors are disposed at different angular positions on the first surface on a circumference of the fixed reference member. In some embodiments, the plurality of sensors are disposed at different angular positions on the second surface on the rotatable selector.

In some embodiments, the processor is configured to operate the proximity sensor or the plurality of proximity sensors at a plurality of sensor power levels.

A rotational position sensor assembly for detecting the selected rotational position of a rotatable selector is provided including a reference member positioned about an axis; a proximity sensor disposed on the reference member; a rotatable selector defining an inner surface, the rotatable selector mounted about the reference member and rotatable about the axis, the inner surface and the proximity sensor defining a gap there between, wherein the gap varies with respect to the rotational position of the rotatable selector, the proximity sensor generating a signal proportional to the size of the gap; and a processor and a non-transitory computer readable storage medium, the computer readable storage medium including instructions executable by the processor to receive the signal proportional to the size of the gap from the proximity sensor; and correlate the signal with a rotational position of the rotatable selector.

In some embodiments, the processor is configured to correlate the rotational position of the rotatable selector with a user selected setting. In some embodiments, the processor is configured to generate an output signal corresponding to the user selected setting.

In some embodiments, the user selected setting is a magnification setting. In some embodiments, the fixed reference member is a ring defining a central opening. In some embodiments, the proximity sensor is an optical proximity sensor. In some embodiments, the gap includes a range of 1-5 mm. In some embodiments, the selector is a ring.

In some embodiments, the rotational position sensor assembly comprises a plurality of proximity sensors disposed on the fixed reference member, wherein each of the proximity sensors generates a signal proportional to the size of the gap between it and the inner surface of the rotatable selector and the processor receives the signals proportional to the size of the gap from each of the proximity sensors; and correlates the signals with the rotational position of the rotatable selector. In some embodiments, the plurality of sensors are disposed at different angular positions around an outer surface on a circumference of the fixed reference member.

In some embodiments, the processor is configured to operate the proximity sensor or the plurality of proximity sensors at a plurality of sensor power levels.

In a further aspect of the disclosed subject matter, provided is an aiming device for displaying a down-range image and a reticle display field comprising: a housing defining an axis; an objective disposed in the housing for producing the image of the down-range image; an eyepiece disposed in the housing for displaying a down-range image and a reticle display field; a lens element disposed in the housing and having adjustable optical magnification; a rotational position sensor assembly comprising: a fixed reference ring positioned about the axis; one or a plurality of proximity sensors disposed on the fixed reference ring; a rotatable selector to adjust an optical magnification of the image of the down-range image, the selector defining an inner surface, the rotatable selector mounted about the fixed reference member and rotatable about the axis, the inner surface and the proximity sensor defining a gap there between, wherein the gap varies with respect to the rotational position about the axis of the rotatable selector, the one or the plurality of proximity sensors generating signals proportional to the size of the gap; and a processor and a non-transitory computer readable storage medium, the computer readable storage medium including instructions executable by the processor to: receive the signals proportional to the size of the gap from the one or the plurality of proximity sensors; and correlate the signals with a rotational position of the rotatable selector.

Embodiments include the following, alone or in any combination.

The aiming device wherein the processor is further configured to correlate the rotational position of the rotatable selector with a user selected setting.

The aiming device wherein the user selected setting is a magnification setting.

The aiming device wherein the one or the plurality of proximity sensors are optical proximity sensors.

The aiming device wherein gap includes a range of 1-5 mm.

The aiming device wherein the one or the plurality of proximity sensors are operated at a plurality of power levels.

The aiming device comprising the plurality of proximity sensors.

An aiming device for displaying a down-range image and a reticle display field is provided including a housing defining an axis; an objective disposed in the housing for producing the image of the down-range image; an eyepiece disposed in the housing for displaying a down-range image and a reticle display field; a lens element disposed in the housing and having adjustable optical magnification; a rotational position sensor assembly comprising: a fixed reference ring positioned about the axis; a proximity sensor disposed on the fixed reference ring; a rotatable selector to adjust an optical magnification of the image of the down-range image, the selector defining an inner surface, the rotatable selector mounted about the fixed reference member and rotatable about the axis, the inner surface and the proximity sensor defining a gap there between, wherein the gap varies with respect to the rotational position about the axis of the rotatable selector, the proximity sensor generating a signal proportional to the size of the gap; and a processor and a non-transitory computer readable storage medium, the computer readable storage medium including instructions executable by the processor to receive the signal proportional to the size of the gap from the proximity sensor; and correlate the signal with a rotational position of the rotatable selector.

In some embodiments, the processor is configured to correlate the rotational position of the rotatable selector with a user selected setting. In some embodiments, the processor is configured to generate an output signal corresponding to the user selected setting.

In some embodiments, the user selected setting is a magnification setting. In some embodiments, the fixed reference member is a ring defining a central opening. In some embodiments, the proximity sensor is an optical proximity sensor. In some embodiments, the gap includes a range of 1-5 mm. In some embodiments, the selector is a ring.

In some embodiments, the rotational position sensor assembly comprises a plurality of proximity sensors disposed spaced apart on the fixed reference member, wherein each of the proximity sensors generates a signal proportional to the size of the gap between it and the inner surface of the rotatable selector and the processor receives the signals proportional to the size of the gap from each of the proximity sensors; and correlate the signals with the rotational position of the rotatable selector. In some embodiments, the plurality of sensors are disposed at different angular positions around the axis.

In some embodiments, the processor is configured to operate the proximity sensor or the plurality of proximity sensors at a plurality of sensor power levels.

Another aspect provides an aiming device for displaying a down-range image and a reticle display field comprising: a housing defining an axis; an objective disposed in the housing for producing the image of the down-range image; an eyepiece disposed in the housing for displaying a down-range image and a reticle display field; a lens element disposed in the housing and having adjustable optical magnification; a rotational position sensor assembly comprising: a fixed reference ring positioned about the axis; a plurality of proximity sensors disposed on the fixed reference ring; a rotatable selector to adjust an optical magnification of the image of the down-range image, the selector defining an inner surface, the rotatable selector mounted about the fixed reference member and rotatable about the axis, the inner surface and the proximity sensor defining a gap there between, wherein the gap varies with respect to the rotational position about the axis of the rotatable selector, the plurality of proximity sensors generating signals proportional to the size of the gap; and a processor and a non-transitory computer readable storage medium, the computer readable storage medium including instructions executable by the processor to: operate the plurality of proximity sensors at a plurality of sensor power levels; receive the signals proportional to the size of the gap from the plurality of proximity sensors; and correlate the signals with a rotational position of the rotatable selector.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIGS. 1-2 illustrates a rotatable selector in a first and second position.

FIGS. 3-4 illustrates another rotatable selector in a first and second position.

FIG. 5 is a perspective view of a sensor assembly used in a firearm scope in accordance with an exemplary embodiment of the disclosed subject matter.

FIG. 6 is a longitudinal cross section view of the rotational position sensor assembly taken along lines 6-6 of FIG. 5.

FIG. 7A is an enlarged view of the longitudinal cross section of FIG. 6 with a lens carriage in a first position.

FIG. 7B is an enlarged view of the longitudinal cross section of FIG. 6 with a lens carriage in a second position.

FIG. 8 is an enlarged view of the longitudinal cross section of FIG. 6 taken at the selector ring.

FIG. 9 is an enlarged longitudinal cross-section of the scope of FIG. 5 rotated from the position of FIG. 8.

FIG. 10 is a side view of the selector ring of the scope in accordance with an exemplary embodiment of the disclosed subject matter.

FIG. 11 is a cross-sectional view in perspective of the selector ring taken along line 11-11 of FIG. 10 in accordance with an exemplary embodiment of the disclosed subject matter.

FIG. 12A is an axial cross-sectional view of the rotational position sensor assembly in a first position, taken along line 12-12 of FIG. 5.

FIG. 12B is an axial cross-sectional view of the rotational position sensor assembly with multiple sensors in a first position, taken along line 12-12 of FIG. 5.

FIG. 13A is an axial cross-sectional view of the rotational position sensor assembly in a second position, taken along line 13-13 of FIG. 5.

FIG. 13B is an axial cross-sectional view of the rotational position sensor assembly with multiples sensors in a second position, taken along line 13-13 of FIG. 5.

FIG. 14 is an enlarged view of the rotation position sensor illustrated in FIGS. 12A-13B.

FIG. 15 is a plot illustrating the gap distance vs. sensor output.

FIG. 16A is a plot illustrating the sensor output at different sensitivity levels for a single sensor.

FIG. 16B is a plot illustrating the sensor output at different sensitivity levels for multiple sensors.

### DETAILED DESCRIPTION OF EXEMPLARY EMBODIMENTS

Various aspects of the apparatuses and methods disclosed herein are described more fully hereinafter with reference to the accompanying drawings. This disclosure may, however, be embodied in many different forms and should not be construed as limited to any specific structure or function presented throughout this disclosure.

As used throughout the description herein a rotatable selector or control device is rotated, e.g., by a user, in order to select any number of settings on mechanical and electronic devices. In some embodiments, the selector is a selector ring or a selector knob.

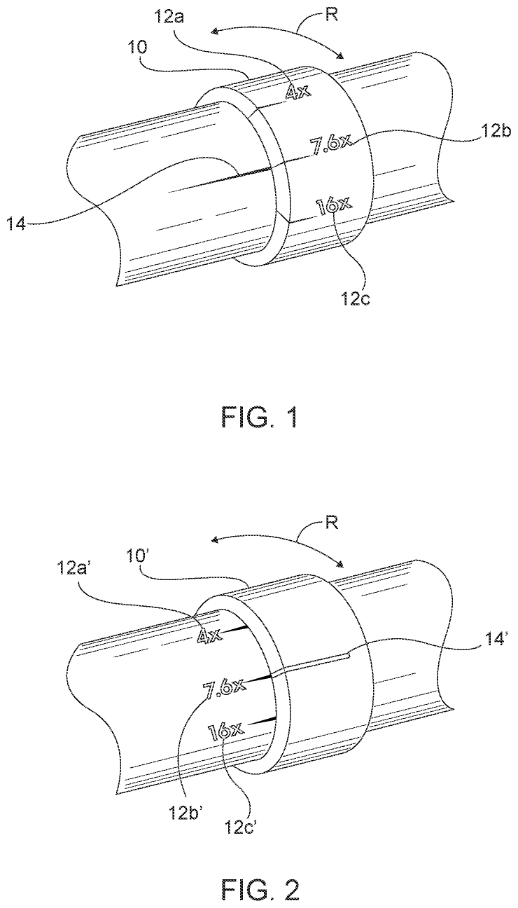

As illustrated in FIG. 1, selector ring 10 typically includes a number of visible markings 12a, 12b, 12c representing a plurality of levels (magnification settings, volume levels, power levels, etc.) The selector ring 10 is rotatable (in direction R) with respect to a stationary reference 14. The user can rotate the selector ring 10 such that the desired level marking 12a, 12b, 12c are aligned with the stationary reference 14. In some cases, as shown in FIG. 2, the selector ring 10′ includes the reference 14′, and the various levels 12a′, 12b′, and 12c′ are fixed. In such case, the user can rotate the selector ring 10′ such that the reference 14′ on the selector ring 10′ is aligned with the desired stationary level marker 12a′, 12b′, and 12c.

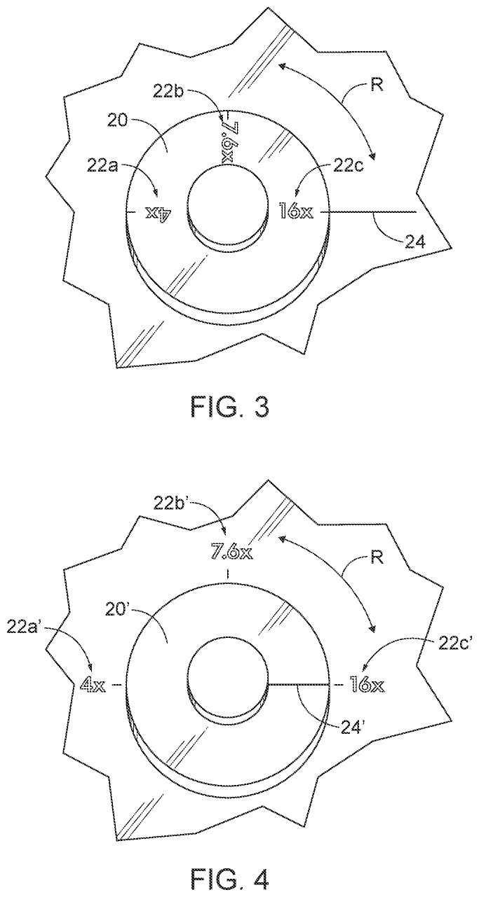

As illustrated in FIG. 3, selector knob 20 is functionally identical to ring 10. Knob 20 includes a number of visible markings 22a, 22b, 22c representing a plurality of levels (magnification settings, volume levels, power levels, etc.) The selector knob 20 is rotatable (in direction R) with respect to a stationary reference 24. The user can rotate the selector knob 20 such that the desired level marking 22a, 22b, 22c are aligned with the stationary reference 24. In some cases, as shown in FIG. 4, the selector knob 20 includes the reference 24′, and the various levels 22a′, 22b′, and 22c′ are fixed. In such case, the user can rotate the selector knob 20′ such that the reference 24′ on the selector knob 20′ is aligned with the desired stationary level marker 22a′, 22b′, and 22c.

User-selected settings can include a magnification setting, a volume setting, a power setting, etc. On the other hand, there may be a need for detect the user-selected setting, e.g., a system input that relies on the user setting. For example, the selector ring or knob may be used to mechanically adjust the magnification setting of a lens on a viewing scope. At the same time, the magnification setting is needed to vary a reticle display in accordance with the magnification setting. Thus, there is a need for the magnification setting, as selected by the selector ring, to be automatically detected and provided to the reticle display system to provide the appropriate scaling of the reticle.

A rotational position sensor assembly is described herein in connection with a firearm scope 100 or other direct view optical aiming device in an exemplary embodiment of the disclosed subject matter. It is understood that the rotational position sensor assembly can be used in connection with other apparatuses for detecting the user-selected rotational position of a rotatable selector ring or knob or control device.

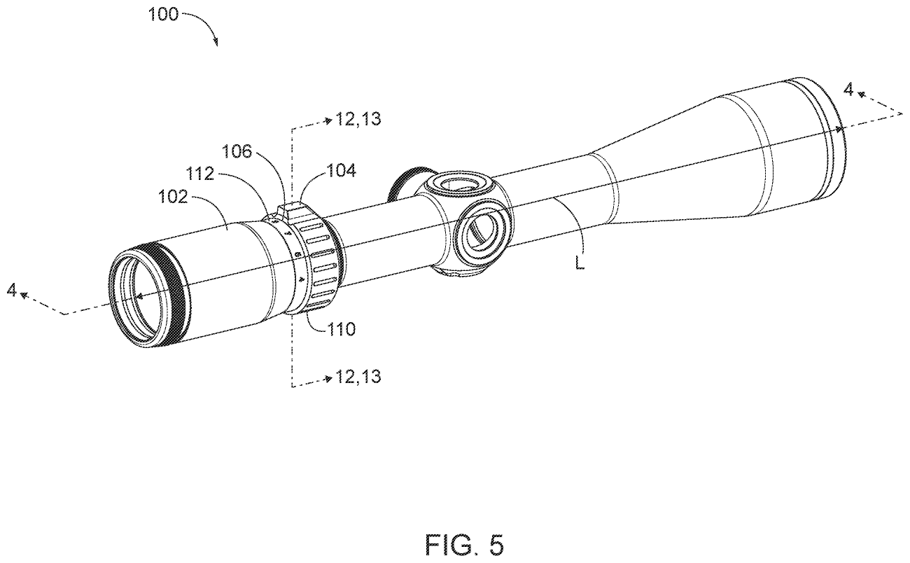

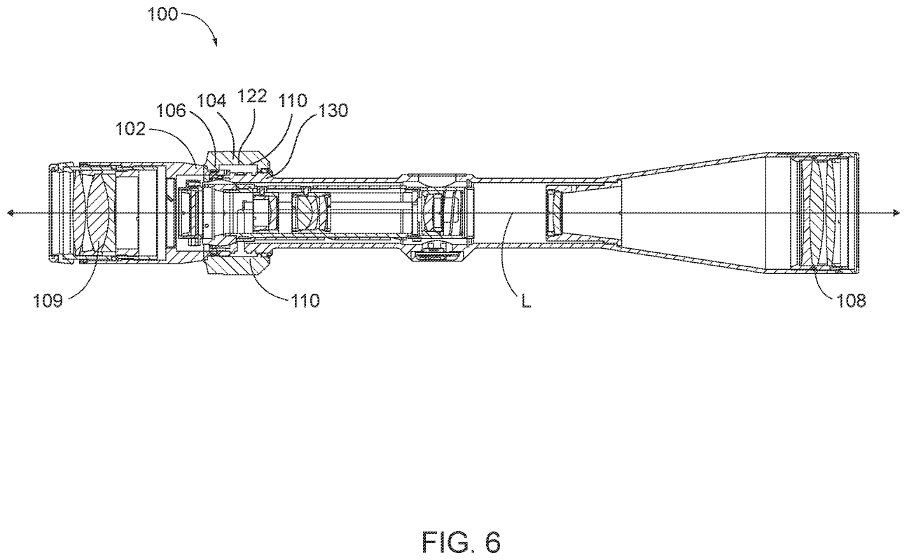

Generally, a direct view optical sighting device includes one or more lenses, prisms, or other optical components that operate to enhance the human eye and may include pistol scopes, spotting scopes, rangefinders, bow sights, or other riflescopes that differ from those specifically discussed herein. FIGS. 5-6 illustrate an exemplary embodiment of a rotational position sensor assembly used with a firearm scope 100 according to the present disclosure. With reference to FIG. 6, scope 100 includes a typically elongated and tubular housing 102 supporting an objective 108 adjacent a target-facing end of the housing 102, an eyepiece 109 adjacent a viewing end of the housing 102.

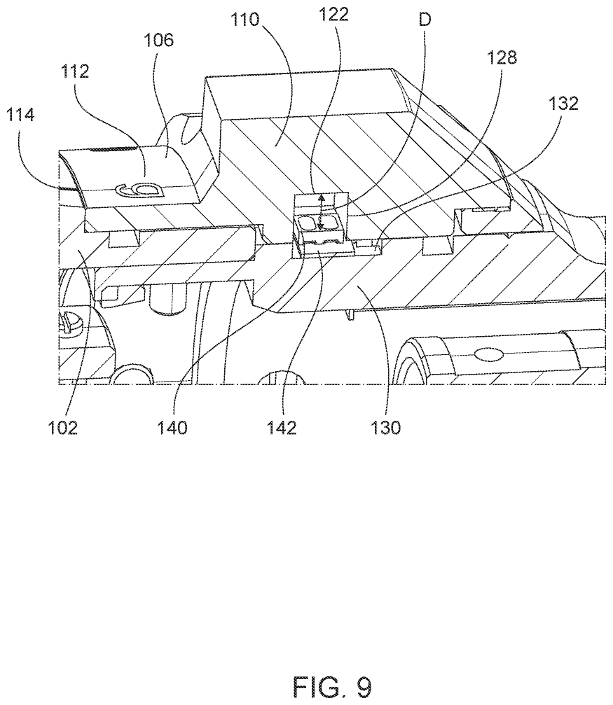

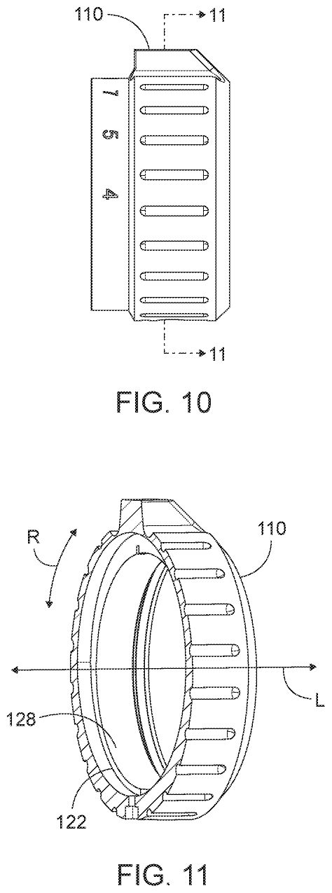

The rotational position sensor assembly used in connection with firearm scope 100 detects a user-selected magnification setting as selected by the rotatable selector ring, or magnification setting ring 110. The magnification setting ring 110 includes a user-engageable portion 104 that may be knurled or textured and a ring portion 106 being inscribed with magnification settings 112. The user may select a magnification setting by rotating the magnification setting ring 110 with respect to the fixed housing 102, and aligning the desired magnification setting 112 with an inscribed reference 114 on the fixed housing 102. (See, e.g., FIG. 9).

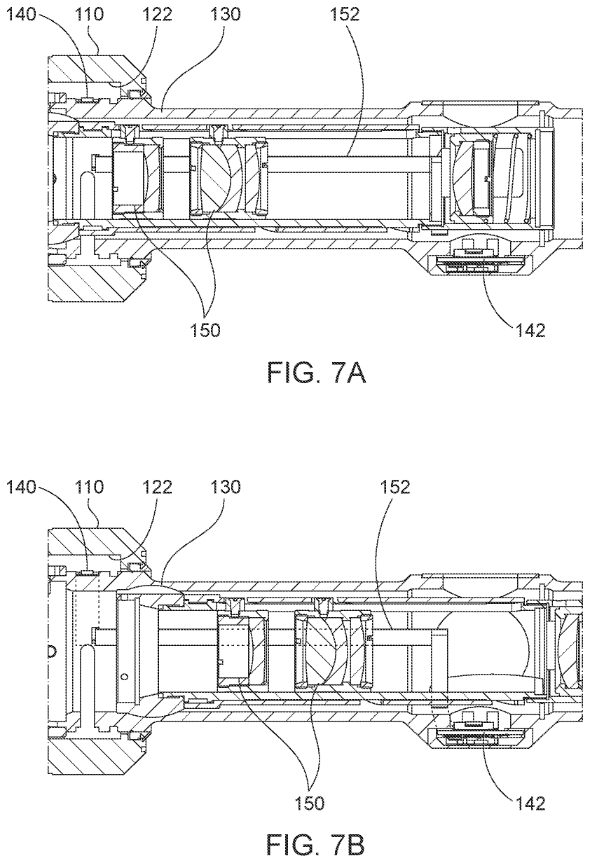

As shown in FIGS. 7A-7B, rotation of the magnification setting ring 110 causes a lens element disposed in the housing and having adjustable optical magnification, e.g., the magnification lens or lens group mounted on an associated carriage 150, to move along the optical axis L to optically magnify the image to vary the size of image visible to the user at the eyepiece 109. As illustrated in FIG. 7A, when the magnification setting ring 110 is rotated to a first position, the magnification lens carriage 150 is positioned at a first location along the optical axis L. As illustrated in FIG. 7B, when the magnification setting ring 110 is rotated to a second position, the magnification lens carriage 150 is positioned at a second location along the optical axis L.

The scope may include an electronic display that generates an image display of a reticle. The reticle may be displayed at the rear focal plane, or alternatively at the front focal plane. The output of the rotational position sensor assembly is in communication with an electronic controller to receive a signal indicative of the adjustment of the magnification by the setting ring 110. The electronic controller may, e.g., continuously resize the reticle in response to the signal indicating a continuous adjustment of the optical magnification of riflescope. In some embodiments the rotational position sensor assembly is used to show correct yardages on a given ballistic drop compensated reticle in the scope 100 or in an application on a connected computing device, such as a mobile device wirelessly connected to the scope 100. In some embodiments, the user can set preferred magnification points. When the preferred magnification points are selected, the scope alerts the user that the selector knob or ring has been rotated to such preferred magnification setting. In some embodiments, the rotational position sensor assembly can be used as an input control when a rotational position is selected. In some embodiments, the rotational position sensor assembly can be used to move up/down or left/right through a menu system. In some embodiments, the rotational position sensor assembly can be used to make adjustments to illumination or other settings in an electronic riflescope. It is understood that the selector ring or knob is useful to use rotational position to provide any number of inputs to an associated system.

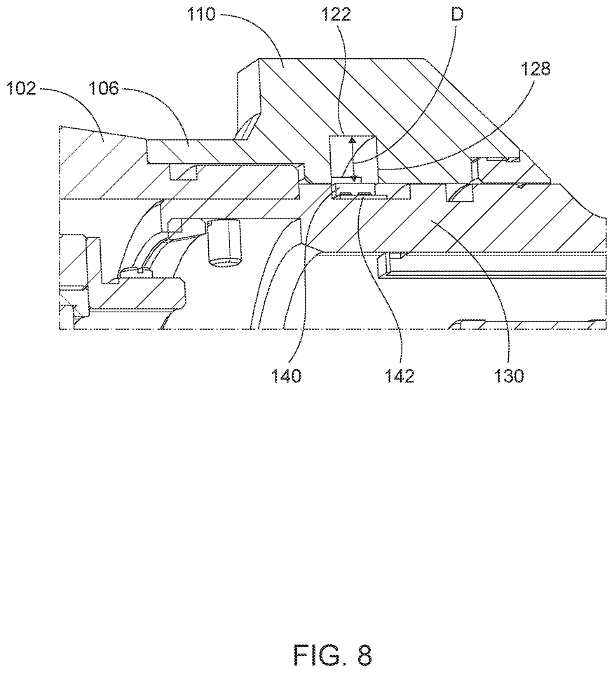

FIGS. 5-9 illustrate the rotational position sensor assembly. In some embodiments, the sensor assembly includes a fixed reference ring 130, a rotatable selector ring 110, a proximity sensor 140 and processor and memory, disposed on a PCB 142. An exemplary processor is an STM32 32-bit microcontroller manufactured by STMicroelectronics, but it is understood that any microcontroller with an ADC would be suitable in this capacity. The reference ring 130 is positioned about the longitudinal axis L and defines an outer surface 132 (See FIG. 9). The reference ring 130 can be fixed with respect to the housing 102. A proximity sensor 140 is disposed on the fixed reference ring 130, and positioned on the ring 130 such that the sensing component is disposed radially outwardly from the longitudinal axis L. As illustrated in FIG. 7B, the proximity sensor 140 is electrically coupled to the PCB 142 via conductor, such as a copper or other metallic ribbon 152 positioned on the inner portion of the housing 102 and partially shown in dashed line.

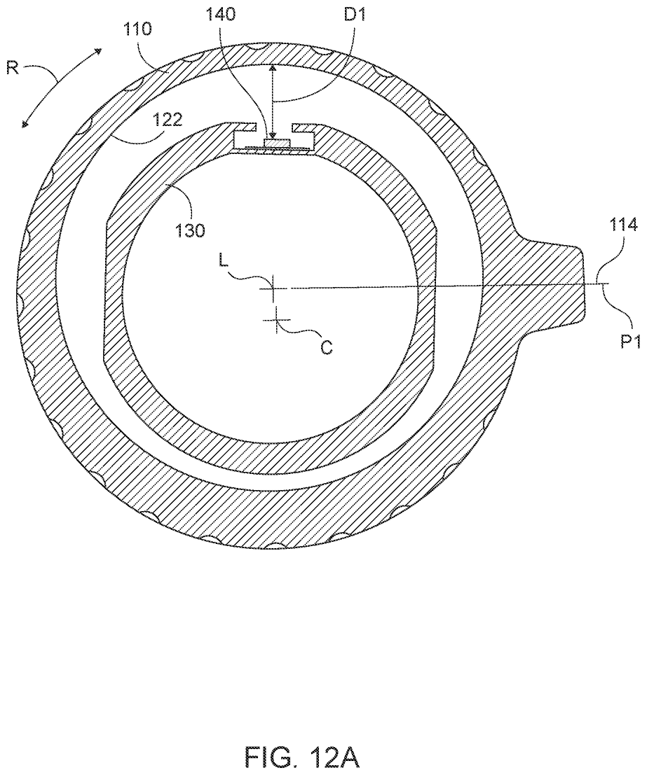

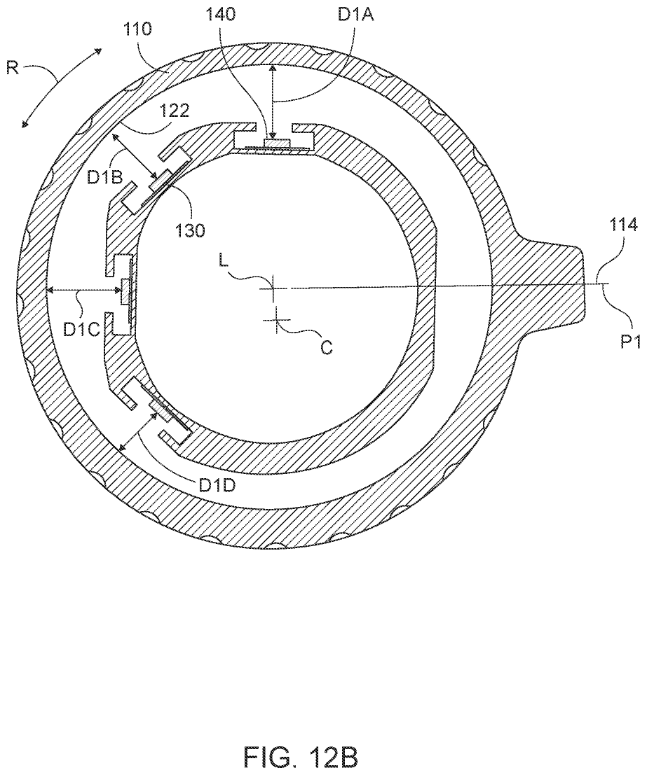

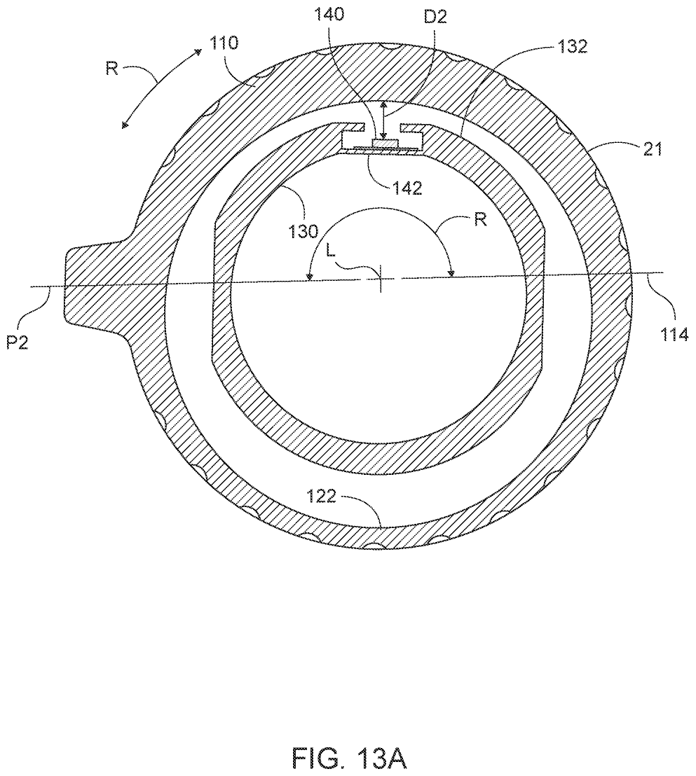

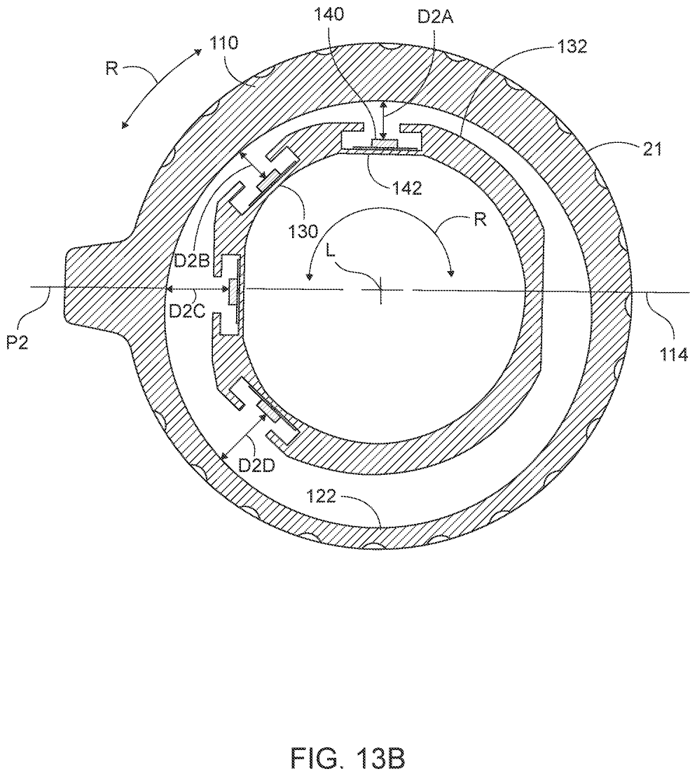

Rotatable selector ring 110 is rotatably mounted about the fixed reference ring 130 about the longitudinal axis L, and has a substantially cylindrical shape. In some embodiments, an annular groove 128 is provided in the inner portion of the ring 110. The groove 128 defines an inner surface 122. As shown in FIG. 12, the inner surface 122 may be substantially circular having a center C that is offset from the longitudinal axis L. In some embodiments, the inner surface 122 is oval or elliptical or other shapes. As shown in FIG. 9, a gap distance D is defined between the inner surface 122 of the rotatable ring 110 and the proximity sensor 140. As shown in FIGS. 12A and 13A, the gap distance D1, D2 varies as the rotatable selector ring 110 is rotated about the longitudinal axis L. Accordingly, the shape of the inner surface 122 defines a “ramp” that varies the gap distance with the rotational position of the selector ring 110. In some embodiments, the inner surface 122 is circular, defining a substantially constant distance from the Longitudinal axis L, and the outer contour 132 defines the ramp that varies the gap distance with the rotational position of the selector ring 110.

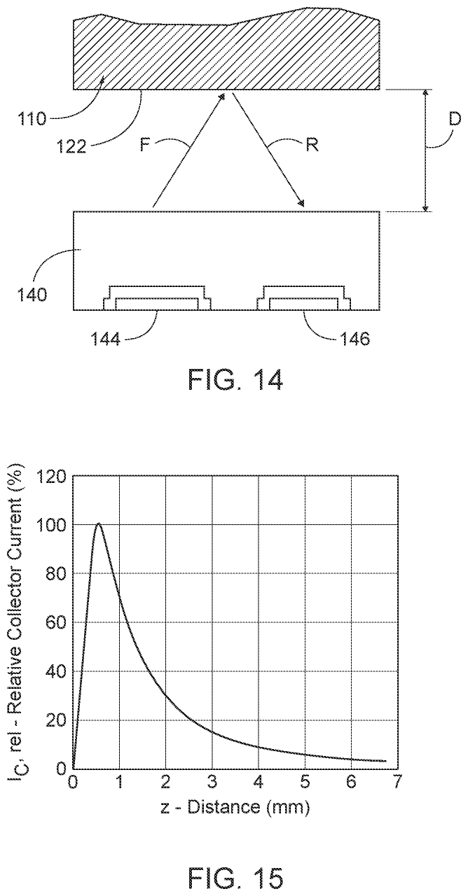

In some embodiments, the proximity sensor 140 is s a reflective optical sensor, such as VCNT2020, manufactured by Vishay Semiconductors. It is understood that any proximity sensor known in the art for measuring the proximity of objects on the order of several millimeters is suitable for use. The proximity sensor arrangement is shown in FIG. 14. The gap distance or working distance D is defined between the proximity sensor 140 and the opposing surface. In the exemplary embodiment, the sensor 140 is disposed on the fixed ring 130, and the opposing surface is the inner surface 122 of selector ring 110. In some embodiments, the sensor 140 is disposed on the selector ring 110, and the opposing surface is disposed on the fixed ring 130. In some embodiments, the sensor 140 includes an LED emitter 144 and a detector 146. The emitter 144 emits light, e.g., IR light at 950 nm, which travels on a forward path F to the inner surface 122. The light is reflected back to the detector 146 on the return path R. As the selector ring 122 is rotated, the gap distance D changes. Accordingly, the light reflected back by the inner surface 122 to the detector 146 also changes. The output of the sensor 140 is a current proportional to the light reflected back to it from the inner surface 122. As shown in FIG. 15, changing the gap distance from 1 mm to 3 mm changes the output current by about 50%. Other proximity sensors known in the art, such as inductive proximity sensors or magnetic proximity sensors may be used to determine the gap distance D.

FIG. 12A illustrates a first position P1 of the rotatable selector ring 110 with respect to the proximity sensor 140 in an exemplary embodiment. Position P1 can be arbitrarily defined as 0° with respect to a reference 114. For example but not limitation, position P1 is associated with a 16× magnification. In this first position, a gap D1 of 3 mm is defined between the inner surface 122 and the proximity sensor 140. The gap D1 is associated with a position P1 of the rotatable selector ring 110.

FIG. 13A illustrates a second position of the rotatable selector ring 110 with respect to the proximity sensor 140 in an exemplary embodiment. Position P2 can be arbitrarily defined as 180° with respect to reference 114. For example but not limitation, position P2 is associated with a 4× magnification. In this second position, a gap D2 of 1 mm is defined between the inner surface 122 and the proximity sensor 140. The gap D2 is associated with a position P2 of the rotatable selector ring 110.

The proximity sensor 140 generates a signal proportional to the size of the gap. For example, the proximity sensor generates a signal S1 associated with gap D1 and a signal S2 associated with gap D2. A data structure, such as a table associating the signal strength with the gap distance D1, D2, etc., and the positions of the rotatable selector ring 110 P1, P2, etc., is stored for access by a processor on the firearm scope 100. Exemplary TABLE 1 illustrates the correlation between the signal strength, the gap distance and the position of the selector ring 110. As will be described in greater detail below, the sensor assembly can be calibrated such that output signal at a first range, e.g., P1, is set to 0%, and the output signal at the second range, e.g., P2, is set to 100%.

TABLE 1

| SIGNAL | GAP | POSITION OF |
|---|---|---|
| STRENGTH | DISTANCE | SELECTOR RING |
| 0% | 3 mm | 0° |
| 50% | 2 mm | 90° |
| 100% | 1 mm | 180° |

In some embodiments, another table is stored to associate the detected position of the rotatable selector ring 110 with a user adjustments such as a magnification setting, a power setting, a volume setting, etc. Exemplary TABLE 2 illustrates the correlation between the user setting, such as magnification, and the position of the selector ring 110.

TABLE 2

| MAGNIFICATION | POSITION OF SELECTOR RING |
|---|---|
| 4x | 0° |
| 7.6x | 90° |
| 16x | 180° |

In some embodiments, a single table is used to provide the correlation between the gap distance, the selector ring position and the user setting.

In embodiments, a plurality of proximity sensors 140 may be used, as shown in FIGS. 12B and 13B. FIG. 12B shows four sensors, but that is not limiting. For example, 1, 2, 3, 4, 5 or more proximity sensors may be used. Each proximity sensor outputs a signal proportional to the gap between it and the inner surface 122 of the selector. Preferably, the plurality of sensors are arranged along the ramp defined by the inner surface 122 and the outer surface 132 so that the sensors have differing gap distances D1B, D1C, D1D compared to D1A. This provides that at least one proximity sensor is positioned in its high-sensitivity region relative to the gap distance D. In the embodiment illustrated, the selector ring is rotated less than a full rotation, so the plurality of proximity sensors 140 are located along a portion of the circumference of the reference member. In other embodiments, the selector ring may be rotated over a full rotation, so the plurality of the proximity sensors may be arranged along the entire circumference of the reference member.

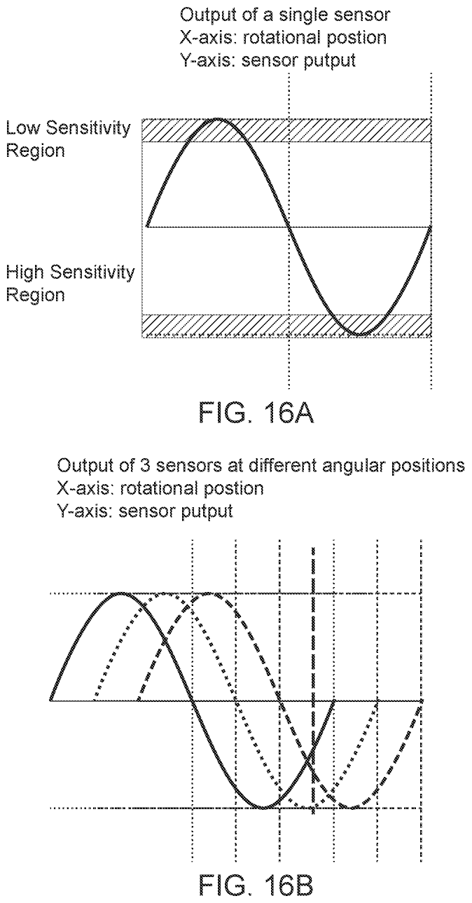

A proximity sensor has a high-sensitivity region and a low-sensitivity region based on the rotational positional change, where high sensitivity is defined as a large output change for small rotational position change. As shown in FIG. 16A, the signal output (y-axis) vs. rotational position change (x-axis) may approximate a sine-curve. The best accuracy can be achieved from a sensor in the high-sensitivity region. FIG. 16B shows the signal output for a plurality of proximity sensors located at different angular positions. Multiple sensors at different angular positions ensure one or more sensors are always in their high-sensitivity region relative to the gap between the reference member and the selector ring.

As shown in FIG. 13B, when the selector ring 110 is rotated, the gap distances for each proximity sensor respectively change from D1A, D1B, D1C and D1D to D2A, D2B, D2C and D2D and their output signals change accordingly. The processor receives the output signals and processes them to determine the rotational position of the selector ring. In some embodiments, the output signals from the plurality of proximity sensors may be aggregated into a single value for comparison to the data structure (table) for determining the rotational position of the selector ring as described above. In other embodiments, the signals from each proximity sensor may be kept separate and the processor may use the separate signals to improve its confidence level for detecting the selector setting by comparing each signal to a reference value in the table. In still other embodiments, the processor may determine which proximity sensors are in their respective high-sensitivity region and may determine a weight to impart to the signals from those sensors. In embodiments, a combination of these methods for processing signals from multiple sensors may be used.

In some embodiments, the proximity sensors may be arranged so that the processor can determine a “primary” sensor and one or more “secondary” sensors, which may enable the processor to count the number of times the selector is in closest proximity to the primary sensor during movement of the selector. This may allow the processor to determine whether the selector has rotated beyond a full revolution around the reference member, in which case the processor may output a signal proportional to more than one revolution of the selector. It may also allow the processor to determine whether the selector was rotated clockwise or counter-clockwise.

In alternative embodiments, the plurality of proximity sensors may be disposed on the inside surface of the selector and each sensor measures the gap between it and the outer surface of the reference member. In these embodiments, the processor can process the output signals of the proximity sensors as described above.

In some embodiments, the proximity sensor(s) are operated at more than one power level, such as 2, or preferably 3 or more power levels, may be used. Using multiple sensor power levels may be used for a single sensor as in FIG. 12A or multiple sensors as in FIG. 12B. Measuring sensor output(s) at multiple sensor power levels may improve noise immunity and overall accuracy. Taking datapoints (i.e sensor output vs. gap distance) across multiple power levels creates a characterization of the sensor and reflective surface. If the curve changes it can indicate a change in the sensor (e.g. aging, damaged, etc.) or the reflective surface (e.g. debris, scratching, etc.) Using the sensor's characteristic curve to measure the distance to the reflective surface can overcome the non-ideal circumstances that may be present at a single power level. A plurality of power levels may be used during the calibration mode described below. A plurality of power levels may also be useful in improving the sensitivity for a proximity sensor at different gaps between the reference member and the selector ring during the operational mode of the proximity sensor(s).

Sweeping among power levels may be performed automatically by the electronics controlled by the processor. For example, at least three discrete power levels may be hard coded for each proximity sensor. Alternatively, the power levels may be adjusted dynamically over a range of power levels, for example, between 0.5× and 2× power levels. For multiple sensors, the power levels may be changed simultaneously or sequentially for the multiple sensors.

The firearm scope 10 includes a processor and a non-transitory computer readable storage medium, which may be disposed on the PCB 142. The computer readable storage medium including instructions, such as software or firmware, executable by the processor to receive the signal proportional to the size of the gap generated by the proximity sensor 140. By reference to the one or more tables stored on the device, the processor correlates the signal generated by the proximity sensor with a rotational position of the rotatable selector ring. For example, a signal strength of 0% (e.g., Gap D1) generated by the sensor 140 is correlated with the position 0° (e.g., P1) of the rotatable selector ring 110. Subsequently, by reference to the one or more tables stored on the device, the rotational position of the rotatable selector ring 110 can be correlated with a user selected setting, such as a magnification setting (e.g., 16×), a power setting, a volume setting, etc. The detected user selected setting is provided as an output for use by the firearm scope 10 or other device. In some embodiments, the detected user selected setting may be correlated to discrete settings, such as a selected magnification setting. In other embodiments, the output signal from the processor is used to define the rotational position of the rotatable selector ring in continuous fashion, such as for a reticle illumination setting. In some embodiments, the detected magnification setting is used to vary a reticle displayed by the scope. For example, the reticle may display the selected magnification setting by illuminating an icon corresponding to the selected magnification setting. For example, on a second-focal plane reticle, the magnification determines the distance of any bullet-drop compensation markings on the reticle. Usually the values for only one magnification setting are known by the user.

In use, the rotational position sensor assembly may need to be calibrated to provide accurate position readings. The sensor output may vary depending upon the LED drive current, the LED optical efficiency, the reflectivity of the inner surface 122 of the selector ring 110, the actual size of the gap D, the sensitivity of the sensor, etc. A calibration will take into account one or more of the variables described above. A first step of the calibration occurs after final assembly of the scope 10. The processor includes a calibration mode. As a second step, selector ring 110 is rotated to the minimum position, e.g., P1 (0°) and the sensor value is set to 0%. As a third step, selector ring 110 is rotated to the minimum position, e.g., P2 (180°) and the sensor value is set to 100%. The calibration mode is then complete. With multiple sensors, intermediate positional settings may also be calibrated to allow the processor to determine how to weight the signals from the various sensors to determine the best matching between the signals from the sensors and the position of the selector ring. Recalibration can be done periodically or as needed to ensure the accuracy of the positional determination during use.

In embodiments, the rotational position sensor may be in operational connectivity with a reticle may be used in optical devices wherein a user views a reticle in an optical path, including riflescopes, binoculars, rangefinders, including laser rangefinders, microscopes, cameras, or other devices. In binoculars, a first rotational position sensor as described herein in operational connectivity with a first reticle may be disposed in a first optical path viewed in a first eyepiece, and optionally a second rotational position sensor as described herein in operational connectivity with a second reticle herein may be disposed in a second optical path viewed in a second eyepiece.

In embodiments, a plurality of rotational position selectors as described herein may be in communication with an electronic controller to receive signals indicative of the rotational positions of the plurality of selectors, wherein the controller is further configured to in operational connectivity to a reticle so that the reticle may display a plurality of images related to and determined by the rotational positions determined by the plurality of rotational position sensors. For example but not limitation, a first display may indicate a magnification setting determined by a first rotational position selector and a second display may comprise an illumination level determined by a second rotational position selector.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations can be understood and effected by those skilled in the art in practicing the claimed disclosure, from a study of the drawings, the disclosure and the appended claims. For example, a selector knob can be substituted for the selector ring to provide the same functionality described herein above.

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

What is claimed is:

1. A rotational position sensor assembly for detecting the selected rotational position of a rotatable selector comprising:
a reference member positioned about an axis;
one or a plurality of proximity sensors disposed on the reference member;
a rotatable selector defining an inner surface, the rotatable selector mounted about the fixed reference member and rotatable about the axis, the inner surface and the proximity sensor defining a gap there between, wherein the gap varies with respect to the rotational position of the rotatable selector, the proximity sensor generating a signal proportional to the size of the gap; and
a processor and a non-transitory computer readable storage medium, the computer readable storage medium including instructions executable by the processor to:
receive signals proportional to the size of the gap from the one or the plurality of proximity sensors; and
correlate the signals with a rotational position of the rotatable selector.

2. The rotational position sensor assembly of claim 1, wherein the processor is further configured to correlate the rotational position of the rotatable selector with a user selected setting.

3. The rotational position sensor assembly of claim 2, wherein the processor is further configured to generate an output signal corresponding to the user selected setting.

4. The rotational position sensor assembly of claim 2, wherein the user selected setting is a magnification setting.

5. The rotational position sensor assembly of claim 1, wherein the reference member is a ring defining a central opening.

6. The rotational position sensor assembly of claim 1, wherein the one or the plurality of proximity sensors are optical proximity sensors.

7. The rotational position sensor assembly of claim 1, wherein gap includes a range of 1-5 mm.

8. The rotational position sensor assembly of claim 1, wherein the selector is a ring.

9. The rotational position sensor assembly of claim 1, wherein the one or the plurality of proximity sensors are operated at a plurality of power levels.

10. The rotational position sensor assembly of claim 1 comprising the plurality of proximity sensors.

11. A rotational position sensor assembly for detecting the selected rotational position of a rotatable selector comprising:
a fixed reference member positioned about an axis and defining a first surface;
a rotatable selector mounted about the fixed reference member and rotatable about the axis, the rotatable selector defining a second surface opposing the first surface;
one or a plurality of proximity sensors disposed on one of the fixed reference member and the rotatable selector, wherein the one or the plurality of proximity sensors and the second surface define a gap therebetween when one or the plurality of proximity sensors are disposed on the fixed reference member and the proximity sensor and the first surface define the gap therebetween when the one or the plurality of proximity sensors are disposed on the rotatable selector, wherein the gap varies with the rotational position about the axis of the rotatable selector with respect to the fixed reference member, the one or the plurality of proximity sensors generating signals proportional to the size of the gap; and
a processor and a non-transitory computer readable storage medium, the computer readable storage medium including instructions executable by the processor to:
receive signals proportional to the size of the gap from the one or the plurality of proximity sensors; and
correlate the signals with a rotational position of the rotatable selector.

12. The rotational position sensor assembly of claim 11, wherein the processor is further configured to correlate the rotational position of the rotatable selector with a user selected setting.

13. The rotational position sensor assembly of claim 12, wherein the user selected setting is a magnification setting.

14. The rotational position sensor assembly of claim 11, wherein the fixed reference member is a ring defining a central opening.

15. The rotational position sensor assembly of claim 11, wherein the one or the plurality of proximity sensors are optical proximity sensors.

16. The rotational position sensor assembly of claim 11, wherein the gap includes a range of 1-5 mm.

17. The rotational position sensor assembly of claim 11, wherein the processor is further configured to generate an output signal corresponding to the user selected setting.

18. The rotational position sensor assembly of claim 11, wherein the selector is a ring.

19. The rotational position sensor assembly of claim 11, wherein the one or the plurality of proximity sensors are operated at a plurality of power levels.

20. The rotational position sensor assembly of claim 11 comprising the plurality of proximity sensors.

21. An aiming device for displaying a down-range image and a reticle display field comprising:
a housing defining an axis;
an objective disposed in the housing for producing the image of the down-range image;
an eyepiece disposed in the housing for displaying a down-range image and a reticle display field;
a lens element disposed in the housing and having adjustable optical magnification;
a rotational position sensor assembly comprising:
a fixed reference ring positioned about the axis;
one or a plurality of proximity sensors disposed on the fixed reference ring;
a rotatable selector to adjust an optical magnification of the image of the down-range image, the selector defining an inner surface, the rotatable selector mounted about the fixed reference member and rotatable about the axis, the inner surface and the proximity sensor defining a gap there between, wherein the gap varies with respect to the rotational position about the axis of the rotatable selector, the one or the plurality of proximity sensors generating signals proportional to the size of the gap; and
a processor and a non-transitory computer readable storage medium, the computer readable storage medium including instructions executable by the processor to:
receive the signals proportional to the size of the gap from the one or the plurality of proximity sensors; and
correlate the signals with a rotational position of the rotatable selector.

22. The aiming device of claim 21, wherein the processor is further configured to correlate the rotational position of the rotatable selector with a user selected setting.

23. The aiming device of claim 22, wherein the user selected setting is a magnification setting.

24. The aiming device of claim 21, wherein the one or the plurality of proximity sensors are optical proximity sensors.

25. The aiming device of claim 21, wherein gap includes a range of 1-5 mm.

26. The aiming device of claim 21, wherein the one or the plurality of proximity sensors are operated at a plurality of power levels.

27. The aiming device of claim 21 comprising the plurality of proximity sensors.

28. An aiming device for displaying a down-range image and a reticle display field comprising:
a housing defining an axis;
an objective disposed in the housing for producing the image of the down-range image;
an eyepiece disposed in the housing for displaying a down-range image and a reticle display field;
a lens element disposed in the housing and having adjustable optical magnification;
a rotational position sensor assembly comprising:
a fixed reference ring positioned about the axis;
a plurality of proximity sensors disposed on the fixed reference ring;
a rotatable selector to adjust an optical magnification of the image of the down-range image, the selector defining an inner surface, the rotatable selector mounted about the fixed reference member and rotatable about the axis, the inner surface and the proximity sensor defining a gap there between, wherein the gap varies with respect to the rotational position about the axis of the rotatable selector, the plurality of proximity sensors generating signals proportional to the size of the gap; and
a processor and a non-transitory computer readable storage medium, the computer readable storage medium including instructions executable by the processor to:
operate the plurality of proximity sensors at a plurality of sensor power levels;
receive the signals proportional to the size of the gap from the plurality of proximity sensors; and
correlate the signals with a rotational position of the rotatable selector.
